(19) United States
(12) Patent Application Publication
(10) Pub. No.: US 2023/0062877 A1
(43) Pub. Date: Mar. 2, 2023

(54) SOLUTION MANAGEMENT SYSTEM AND SOLUTION MANAGEMENT METHOD

(71) Applicant: Hitachi, Ltd., Tokyo (JP)

(72) Inventors: Yusuke ARAI, Tokyo (JP); Yoji OZAWA, Tokyo (JP); Kentaro WATANABE, Tokyo (JP); Shin TEZUKA, Tokyo (JP)

(21) Appl. No.: 17/900,589

(22) Filed: Aug. 31, 2022

(30) Foreign Application Priority Data
Sep. 2, 2021 (JP) 2021-142908

(51) Int. Cl. G06Q 30/02

(52) U.S. Cl. CPC G06Q 30/0208; G06Q 30/0239

(57) ABSTRACT

A generation unit that generates a user interface in which a user is allowed to select an incentive associated with a solution; a storage unit that stores information indicating an incentive, associated with a solution, selected by a user in a user interface generated by the generation unit, information indicating the solution, and information indicating the user in association with each other; an execution unit that monitors whether an application related to a solution is available and executes a process related to an incentive associated with a solution of the available application; and an output unit that outputs a fact that the process related to the incentive is executed by the execution unit are provided.

### BACKGROUND OF THE INVENTION

### 1. Field of the Invention

The present invention relates generally to a technique for managing a solution that is a product for leveraging digital technology.

### 2. Description of the Related Art

In recent years, there has been a demand for digital transformation (DX) that appropriately and quickly realizes services utilizing digital technologies such as artificial intelligence (AI) and Internet of Things (IoT). However, in order to realize digital transformation, many expertise and know-how are required, such as environment construction utilizing software and hardware, application development, transition to a real environment, maintenance, and operation, and enormous cost and time are required.

In this regard, a market place is being utilized in which a solution combining expertise and know-how is packaged in an easily introducible form, registered in a catalog, and provided on a cloud infrastructure. With the market place, it is possible to easily build an environment on infrastructure as a service (IaaS) and quickly start use by simply selecting a solution to be introduced from a catalog.

In conventional system integration (SI), at least a solution demanded by a customer can be developed by obtaining a requirement of the customer in advance. However, when a solution is deployed on a market place, it is not possible to grasp the demand in advance. Therefore, entry hurdles are high particularly for companies that have performed conventional SI.

Recently, there has been known cloud funding for determining merchandise that is expected to be in demand by prior investment (see JP 2021-77301 A).

### SUMMARY OF THE INVENTION

Here, since the purchasing side expresses the intention to purchase by the investment amount, the cloud foundation is a system that can accurately grasp the demand. In a case where there is a cost restriction such as crowdfunding, an intention of a solution utilization side is correctly expressed, so that a solution development side can accurately grasp a demand for a solution. However, in a case where the amount of money handled in the Business to Business (B to B) solution is large, it is difficult to make a prior investment on the solution utilization side, and there is a case where cloud funding cannot be used.

In this regard, in order to grasp the demand for the solution, it is conceivable to adopt a questionnaire regarding the necessity of the solution, a mechanism in which the solution utilization side “likes” the idea posted in the market, and the solution development side knows who the demand is from, and the like.

Such prediction of demand is based on the premise that the solution utilization side correctly expresses its intention, but there is no guarantee that the intention is correctly expressed in a case where there is no cost restriction such as crowdfunding, that is, there is no disadvantage even if the purchase side takes an action different from the intention to purchase.

The present invention has been made in view of the above points, and an object of the present invention is to propose a solution management system or the like that can appropriately grasp a demand for a solution.

In order to solve such a problem, according to the present invention, provided is a solution management system for managing a solution that is a product for utilizing digital technology, where the solution management system includes a generation unit that generates a user interface in which a user is allowed to select an incentive associated with a solution, a storage unit that stores information indicating an incentive, associated with a solution, selected by a user in a user interface generated by the generation unit, information indicating the solution, and information indicating the user in association with each other, an execution unit that monitors whether an application related to a solution is available and executes a process related to an incentive associated with a solution of the available application, and an output unit that outputs a fact that the process related to the incentive is executed by the execution unit.

According to the above configuration, for example, since an incentive associated with the solution can be obtained, the user expresses an intention according to his/her preference, and the accuracy of the intention expression can be improved. In addition, since the information indicating the solution associated with the incentive selected by the user is stored, for example, the owner of the solution can accurately grasp the demand for the solution.

According to the present invention, it is possible to realize a highly convenient solution management system.

### BRIEF DESCRIPTION OF THE DRAWINGS

FIG. 1 is a diagram illustrating an example of a solution management system according to a first embodiment;

FIG. 2 is a diagram illustrating an example of a server device constituting a platform environment according to the first embodiment;

FIG. 3 is a diagram illustrating an example of incentive definition information according to the first embodiment;

FIG. 4 is a diagram illustrating an example of upper limit number definition information according to the first embodiment;

FIG. 5 is a diagram illustrating an example of solution management information according to the first embodiment;

FIG. 6 is a diagram illustrating an example of user management information according to the first embodiment;

FIG. 7 is a diagram illustrating an example of incentive execution management information according to the first embodiment;

FIG. 8 is a diagram illustrating an example of a user screen generation process according to the first embodiment;

FIG. 9 is a diagram illustrating an example of an incentive execution process according to the first embodiment;

FIG. 10 is a diagram illustrating an example of an incentive execution process according to the first embodiment;

FIG. 11 is a diagram illustrating an example of a user screen according to the first embodiment;

FIG. 12 is a diagram illustrating an example of a developer screen according to the first embodiment;

FIG. 13 is a diagram illustrating an example of solution management information according to a second embodiment;

FIG. 14 is a diagram illustrating an example of solution management information according to the second embodiment; and

FIG. 15 is a diagram illustrating an example of a user screen according to the second embodiment.

### DESCRIPTION OF THE PREFERRED EMBODIMENTS

### (I) First Embodiment

Hereinafter, an embodiment of the present invention will be described in detail. However, the present invention is not limited to the embodiments.

In the solution management system of the present embodiment, for example, an application generated based on the solution is packaged in a reusable form and accumulated in a catalog by applying open source software (OSS) such as “Docker” that provides a container type virtualization environment and “Kubernetes” that performs container setting and management. This enables a user of the solution (for example, SI: system integrator) to build an environment on IaaS according to a use application and use an application of the solution only by selecting the solution to be introduced. Note that, in the present embodiment, as a solution application, a container will be appropriately described as an example.

In addition, in the present solution management system, a base (platform) for managing the solution executes the process related to an incentive selected by the user based on information on the incentive associated with the solution selected by the user. The incentive associated with the solution is an incentive specific to the solution, and is a benefit obtained when the user uses the container generated based on the solution. Examples of the incentive associated with the solution include a right of use, a right of exemption from charging, a right of meeting, and the like. The right of use is a right that allows the user to use the solution (formal solutions, test solutions, etc.). The right of exemption from charging is a right to be released from charging for a certain period of time when using the solution. The right of meeting is a right that allows the user to provide a meeting (for example, online meeting via platform) for conveying individual requests and the like for the solution to the owner of the solution (the development side including the developer and the like).

In addition, in the present solution management system, for example, the deployment destination of the container is assigned in advance, and the platform may monitor the deployment of the container to promptly perform the process related to the incentive in accordance with the timing of the deployment of the container.

Furthermore, in the present solution management system, an incentive associated with a solution may be freely set by the development side among options given from the platform, and the platform may manage the information.

In addition, in the present solution management system, by preparing a plurality of incentives having different strengths of user's intention expression and/or having different selectable upper limit numbers, the accuracy of demand prediction by the development side may be improved.

Next, an embodiment of the present invention will be described with reference to the drawings. The following description and drawings are examples for describing the present invention, and are omitted and simplified as appropriate for the sake of clarity of description. The present invention can be implemented in various other forms. Unless otherwise specified, each component may be singular or plural. In the following description, the same elements are denoted by the same reference numerals in the drawings, and the description thereof will be omitted as appropriate.

Notations such as “first”, “second”, and “third” in the present specification and the like are attached to identify components, and do not necessarily limit the number or order. In addition, a number for identifying a component is used for each context, and a number used in one context does not necessarily indicate the same configuration in another context. In addition, it does not prevent a component identified by a certain number from also functioning as a component identified by another number.

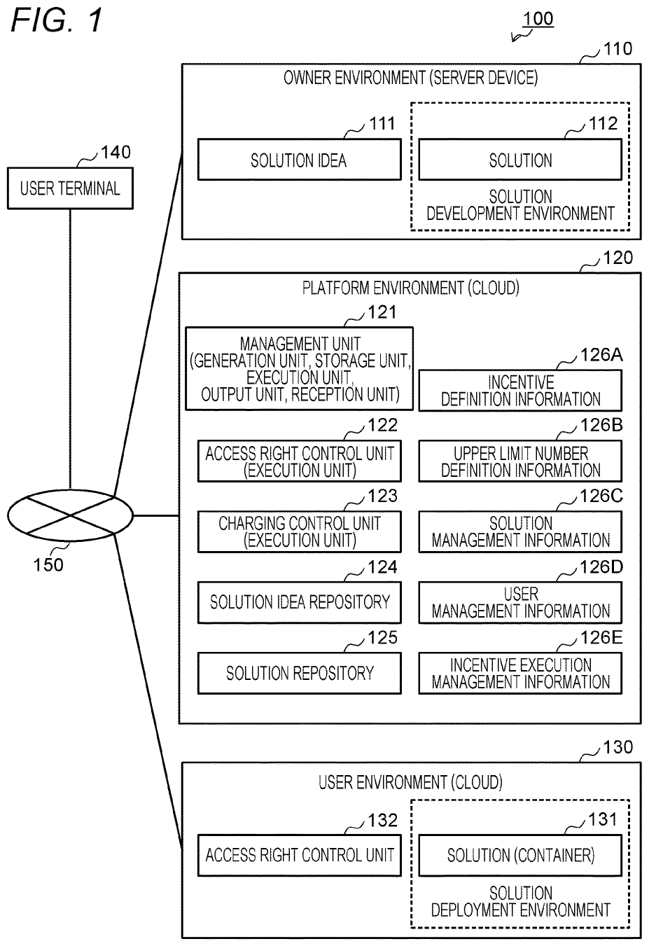

FIG. 1 is a diagram illustrating an example of a solution management system 100 according to the present embodiment.

In the solution management system 100, an owner environment 110, a platform environment 120, a user environment 130, and a user terminal 140 are communicably connected via a network 150.

The owner environment 110 is an environment used by the owner of a solution idea 111 and a solution 112. The owner environment 110 includes, for example, a server device. In the owner environment 110, the solution idea 111 and the solution 112 are developed (generated) based on an instruction (input) by the owner.

The solution idea 111 is an idea of the solution 112 presented to the user. The user who has confirmed the solution idea 111 selects (express an intention) whether to use the solution 112, whereby the demand for the solution 112 is predicted. The solution idea 111 includes a title of the solution 112, an image such as a conceptual diagram and a schematic diagram of the solution 112, an idea content of the solution 112, and the like. The solution idea 111 is created by a developer and stored (managed) in the platform environment 120.

The solution 112 is a product including expertise, know-how, and the like for utilizing digital technology available for a user to perform a predetermined operation. More specifically, the solution 112 is an aggregate of a file for a file system such as a command and a library for accessing the host OS, a file for an application for generating an application for performing a predetermined operation, and meta information, and is, for example, an image (for example, a Docker image) for generating a container. Solution 112 is developed by a developer in a solution development environment, and is stored (managed) in platform environment 120.

The platform environment 120 is an environment used by an operator of the platform for managing the solution 112. The platform environment 120 is, for example, a cloud configured to include one or a plurality of server devices. The platform environment 120 includes a management unit 121, an access right control unit 122, a charging control unit 123, a solution idea repository 124, and a solution repository 125.

The management unit 121 manages a demand for the solution 112 and the like. The access right control unit 122 manages access to the solution 112. More specifically, the access right control unit 122 controls access to the solution 112, access to a container (not illustrated) generated based on the test solution of the solution 112, and the like. The charging control unit 123 manages charging for use of the solution 112. The solution idea repository 124 stores the solution idea 111. The solution repository 125 stores the solution 112.

In addition, the platform environment 120 includes incentive definition information 126A, upper limit number definition information 126B, solution management information 126C, user management information 126D, and incentive execution management information 126E.

The incentive definition information 126A is information in which an incentive associated with the solution 112 is defined. The upper limit number definition information 126B is information in which the upper limit number (the upper limit number of the user's intention expression) in which the user is allowed to select an incentive associated with the solution 112 is defined. The solution management information 126C is information for managing the solution 112. The solution management information 126C includes information indicating the solution 112 and information indicating an incentive associated with the solution 112. The user management information 126D is information for managing a solution (user's intention expression) associated with the incentive selected by the user. The user management information 126D includes information indicating the user and information indicating the solution 112 with which the incentive selected by the user is associated. The incentive execution management information 126E is information for managing execution (granting) of an incentive.

The user environment 130 is an environment for the user to use the solution 112, and is, for example, a cloud service provided by a cloud vendor. For example, the user environment 130 is a cloud including one or more server devices. The user environment 130 includes one or more containers 131 generated based on the solution 112 and an access right control unit 132.

The container 131 is software that is generated based on the solution 112 and operates in a solution deployment environment. Note that the application (process) disposed in the container 131 uses the kernel of the host OS via the command and the library in the container 131. The access right control unit 132 manages access to the container 131 deployed in the solution deployment environment.

The user terminal 140 is a terminal used by a user, and is a smartphone, a tablet terminal, a notebook personal computer, a personal computer, or the like.

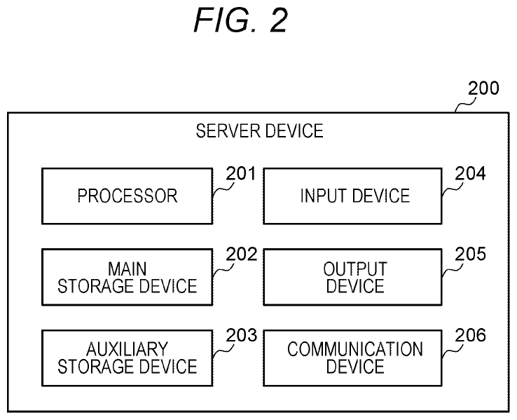

FIG. 2 is a diagram illustrating an example of a server device 200 constituting the platform environment 120.

The server device 200 includes a processor 201, a main storage device 202, an auxiliary storage device 203, an input device 204, an output device 205, and a communication device 206.

The processor 201 is a device that performs arithmetic processing. The processor 201 is, for example, a central processing unit (CPU), a micro processing unit (MPU), a graphics processing unit (GPU), an artificial intelligence (AI) chip, or the like.

The main storage device 202 is a device that stores programs, data, and the like. The main storage device 202 is, for example, a read only memory (ROM), a random access memory (RAM), or the like. The ROM is a static random access memory (SRAM), a non volatile RAM (NVRAM), a mask read only memory (ROM), a programmable ROM (PROM), or the like. The RAM is a dynamic random access memory (DRAM) or the like.

The auxiliary storage device 203 is a hard disk drive, a flash memory, a solid state drive (SSD), an optical storage device, or the like. The optical storage device is a compact disc (CD), a digital versatile disc (DVD), or the like. The programs, data, and the like stored in the auxiliary storage device 203 are read into the main storage device 202 as needed.

The input device 204 is a user interface that receives information from a user. The input device 204 is, for example, a keyboard, a mouse, a card reader, a touch panel, or the like.

The output device 205 is a user interface that outputs (display output, sound output, print output, etc.) various types of information. The output device 205 is, for example, a display device that visualizes various types of information, an audio output device (speaker), a printing device, or the like. The display device is a liquid crystal display (LCD), a graphic card, or the like.

The communication device 206 is a communication interface that communicates with other devices via a communication medium. The communication device 206 is, for example, a network interface card (NIC), a radio communication module, a universal serial interface (USB) module, a serial communication module, or the like. The communication device 206 can also function as an input device that receives information from another device communicably connected. Furthermore, the communication device 206 can also function as an output device that transmits information to another device communicably connected.

The functions (the management unit 121, the access right control unit 122, the charging control unit 123, the solution idea repository 124, the solution repository 125, and the like) of the server device 200 may be realized, for example, by the processor 201 reading a program stored in the auxiliary storage device 203 to the main storage device 202 and executing the program (software), may be realized by hardware such as a dedicated circuit, or may be realized by combining software and hardware. Note that one function of the server device 200 may be divided into a plurality of functions, or the plurality of functions may be integrated into one function. For example, the management unit 121 may be divided into a generation unit, a storage unit, an execution unit, an output unit, a reception unit, and the like. In addition, some of the functions of the server device 200 may be provided as another function or may be included in another function. In addition, some of the functions of the server device 200 may be realized by another server device 200 capable of communicating with the server device 200. Furthermore, the function of the server device 200 may be a virtual machine (VM) that operates on a computer or an application that operates on an operating system (OS). Furthermore, the server device 200 may be a physical server or a virtual server (VM).

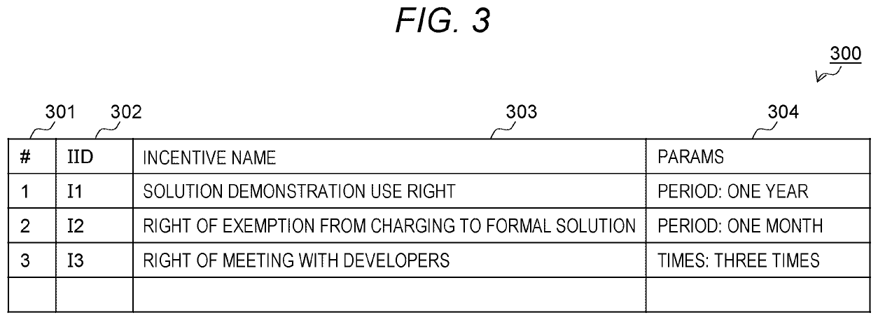

FIG. 3 is a diagram illustrating an example (an incentive definition table 300) of the incentive definition information 126A.

The incentive definition table 300 stores a record (entry) including values of a plurality of items indicating the incentive definition information 126A. More specifically, the incentive definition table 300 stores a record in which information about a record number 301, an incentive ID 302, an incentive name 303, and a parameter 304 is associated.

The record number 301 is a number for identifying a record stored in the incentive definition table 300. The incentive ID 302 is an ID for identifying an incentive to be managed in the incentive definition table 300. The incentive name 303 is a name of an incentive identified by the incentive ID. The parameter 304 is a parameter used when the process related to the incentive is executed.

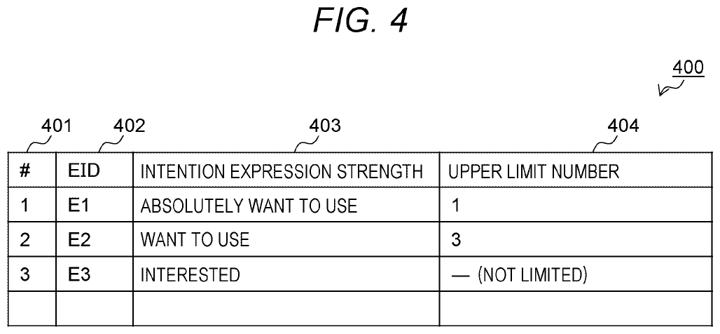

FIG. 4 is a diagram illustrating an example (an upper limit number definition table 400) of the upper limit number definition information 126B.

The upper limit number definition table 400 stores a record including values of a plurality of items indicating the upper limit number definition information 126B. More specifically, upper limit number definition table 400 stores a record in which information about a record number 401, an intention expression ID 402, an intention expression strength 403, and an upper limit number 404 is associated.

The record number 401 is a number for identifying a record stored in the upper limit number definition table 400. The intention expression ID 402 is an ID for identifying the strength of the intention expression to be managed in the upper limit number definition table 400. The intention expression strength 403 is the strength of the intention expression identified by the intention expression ID. The upper limit number 404 is an upper limit number in which the user is allowed to select an incentive associated with the solution 112 with the strength of the intention expression.

In the present embodiment, it is assumed that one of the upper limit numbers defined in the upper limit number definition table 400 is set in advance. Hereinafter, a case where “3” is set as the upper limit number by the operator or the owner will be described as an example.

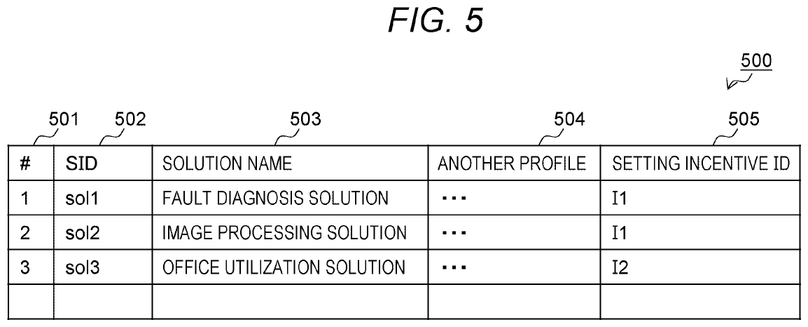

FIG. 5 is a diagram illustrating an example (a solution management table 500) of the solution management information 126C.

The solution management table 500 stores a record including values of a plurality of items indicating the solution management information 126C. More specifically, the solution management table 500 stores a record in which information about a record number 501, a solution ID 502, a solution name 503, another profile 504, and a setting incentive ID 505 is associated.

The record number 501 is a number for identifying a record stored in the solution management table 500. The solution ID 502 is an ID for identifying the solution 112 managed in the solution management table 500. The solution name 503 is a name of the solution 112 identified by the solution ID. The another profile 504 is a profile of the solution 112. The setting incentive ID 505 is an incentive ID of an incentive associated with the solution 112.

In the present embodiment, a case where an incentive is associated with each solution 112 registered in the solution repository 125 by the operator will be described as an example.

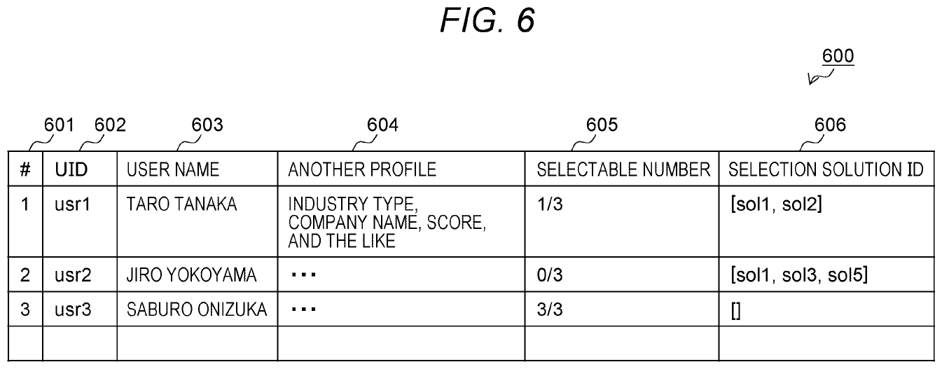

FIG. 6 is a diagram illustrating an example (a user management table 600) of the user management information 126D.

The user management table 600 stores a record including values of a plurality of items indicating the user management information 126D. More specifically, the user management table 600 stores a record in which information about a record number 601, a user ID 602, a user name 603, another profile 604, a selectable number 605, and a selection solution ID 606 is associated.

The record number 601 is a number for identifying a record stored in the user management table 600. The user ID 602 is an ID for identifying a user managed in the user management table 600. The user name 603 is a name of a user identified by the user ID. The another profile 604 is a profile of the user. The selectable number 605 is the number of times (selectable number) the incentive associated with the solution 112 desired to be used by the user can be selected. The selection solution ID 606 is a solution ID of the solution 112 associated with the incentive selected by the user. In addition, the value of the selectable number 605 and the value of the selection solution ID 606 may be reset when a predetermined period (for example, 1 year) elapses.

Note that the user management table 600 is not limited to the above-described contents. For example, the selectable number 605 may not be provided. In this case, the selectable number is calculated by subtracting the number of times of intention expression by the user (the number of selection solution IDs) from the preset upper limit number “3”. Furthermore, for example, an item of an intention expression ID may be provided in the user management table 600. In this case, the selectable number and the selection solution ID can be managed for each strength of the intention expression.

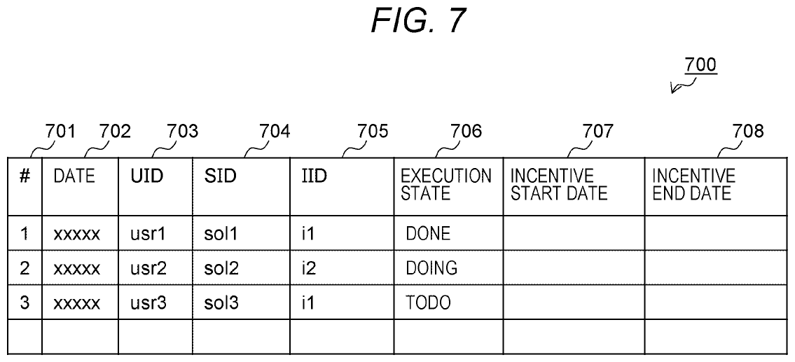

FIG. 7 is a diagram illustrating an example (an incentive execution management table 700) of the incentive execution management information 126E.

The incentive execution management table 700 stores a record including values of a plurality of items indicating the incentive execution management information 126E. More specifically, the incentive execution management table 700 stores a record in which information about a record number 701, a date and time 702, a user ID 703, a solution ID 704, an incentive ID 705, an execution state 706, an incentive start date 707, and an incentive end date 708 is associated.

The record number 701 is a number for identifying a record stored in the incentive execution management table 700. The date and time 702 is a date and time when the record of the record number 701 is registered in the incentive execution management table 700. For example, a record when the user selects an incentive associated with the desired solution 112 is registered (added), and the date and time of the registration is set to the date and time 702. The user ID 703 is an ID for identifying the user. The solution ID 704 is a solution ID of the solution 112 associated with the incentive selected by the user. The incentive ID 705 is an incentive ID of the incentive. The execution state 706 is a state of process related to the incentive (“todo” indicating not-executed, “doing” indicating under execution, “done” indicating executed, and the like). The incentive start date 707 is a date on which the process related to the incentive is started. The incentive end date 708 is a date on which the process related to the incentive ends.

Note that the incentive execution management table 700 is not limited to the content described above. For example, the incentive execution management table 700 may be provided with items such as the remaining number of times of the meeting related to the incentive.

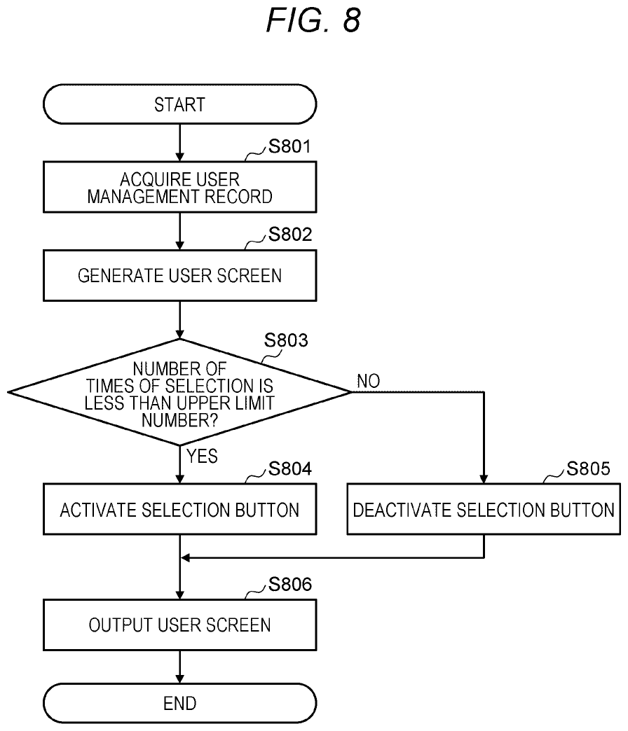

FIG. 8 is a diagram illustrating an example of processing (user screen generation process) of generating a user screen for selecting an incentive associated with the solution 112 desired to be used by the user. The user screen generation process is executed based on a request for a user screen from the user terminal 140. Note that the user ID (or information capable of specifying the user ID) used in the user screen generation process may be included in the request for the user screen and transmitted to the management unit 121, or may be transmitted to the management unit 121 at timing different from the request for the user screen.

In S801, the management unit 121 acquires a record associated with the user ID of the user who has made the request for the user screen from the user management table 600.

In S802, the management unit 121 generates a user screen for each solution 112 managed in the solution management table 500 by using the solution idea 111 registered in the solution idea repository 124. Note that the user screen will be described later using a solution idea page 1100 (an example of a user interface) to be described later.

In S803, the management unit 121 determines whether the value of the selectable number 605 of the record acquired in S801 is “1” or more (whether the number of times of selection is less than the upper limit number). In a case where it is determined that the number of times of selection is less than the upper limit number, the management unit 121 moves the process to S804, and in a case where it is determined that the number of times of selection is not less than the upper limit number, moves the process to S805.

In S804, the management unit 121 activates (a state of receiving an operation by the user) a button (selection button) for selecting an incentive associated with the solution 112 on the user screen generated in S802.

In S805, the management unit 121 deactivates (a state of not receiving an operation by the user) the selection button.

In S806, the management unit 121 transmits (outputs) the user screen to the user terminal 140.

Note that the user screen generation process is not limited to the above-described contents. For example, among the solutions 112 managed by the solution management table 500, the management unit 121 may generate and output a user screen of a solution 112 which the user has not expressed an intention to use. Furthermore, for example, in a case where the number of times of selection is less than the upper limit number, the management unit 121 may generate and output a user screen.

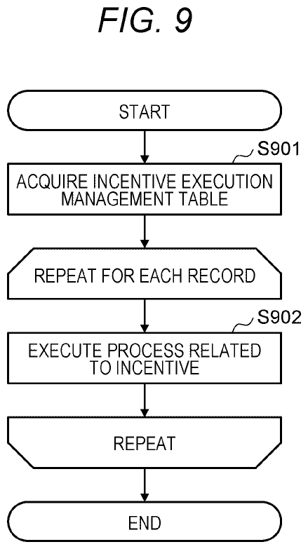

FIG. 9 is a diagram illustrating an example of processing (incentive execution process) for executing process related to an incentive. The incentive execution process is performed at predetermined timing. The predetermined timing may be periodic timing, a preset date and time, timing instructed by a user, an owner, an operator, or the like, or another timing.

In S901, the management unit 121 acquires the incentive execution management table 700. The management unit 121 executes the process of S902 on each record stored in the incentive execution management table 700.

In S902, the management unit 121 executes the process related to an incentive (controlling a right of access, changing a price plan, setting a meeting, etc.). For example, the management unit 121 determines whether the condition of the incentive is satisfied in a case where the execution state 706 of the record to be processed is “todo” (not executed), and executes the process related to the incentive in a case where the condition of the incentive is satisfied. Note that the condition of the incentive is, for example, when a container generated based on a test solution of the solution 112 associated with the incentive selected by the user is deployed, or when the solution 112 associated with the incentive selected by the user is registered in the solution repository 125.

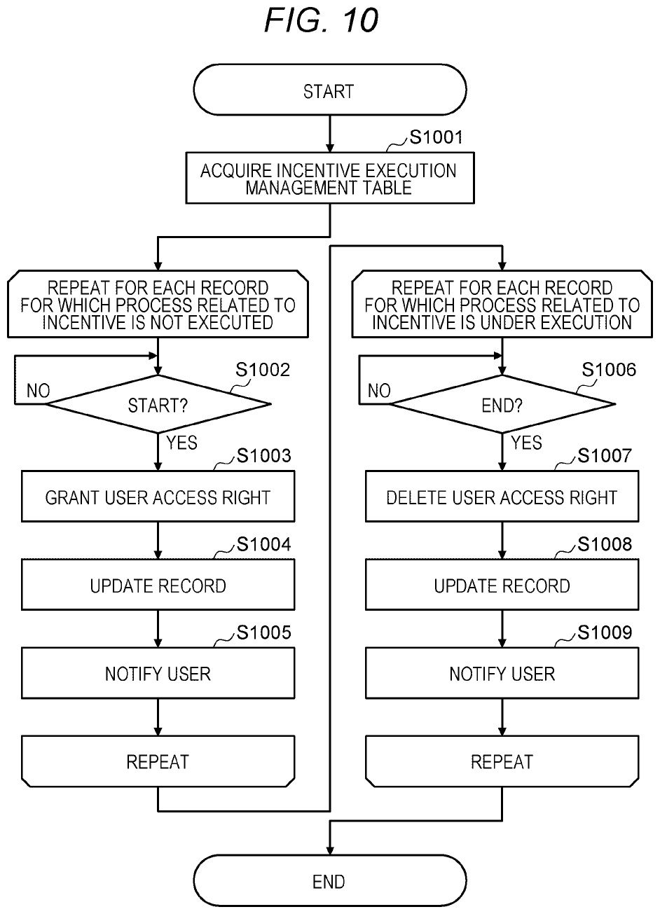

FIG. 10 is a diagram illustrating an example of an incentive execution process in a case where the incentive is the right of use (right of demonstration use) of the test solution of the solution 112.

In S1001, the management unit 121 acquires the incentive execution management table 700.

The management unit 121 performs the process of S1002 to S1005 on each record in which the incentive is the right of demonstration use (the value of the incentive ID 705 is “I1”) and the process related to the incentive is not executed (the value of the execution state 706 is “todo”) among the records stored in the incentive execution management table 700.

In S1002, the management unit 121 determines whether the condition of the incentive is satisfied (whether the process related to the incentive is started) based on the record to be processed.

More specifically, the management unit 121 determines whether a container (demonstration version) generated based on a test solution of the solution 112 identified by the solution ID of the solution ID 704 of the record to be processed is deployed in a place assigned in advance. In a case where it is determined that the container is deployed, the management unit 121 moves the process to S1003, and in a case where it is determined that the container is not deployed, the management unit 121 changes a record to be processed to the next record and moves the process to S1002.

In S1003, the access right control unit 122 grants a right of access to the demonstration version (container) to the user identified by the user ID of the user ID 703 of the record to be processed.

In S1004, the management unit 121 updates the record to be processed. For example, the management unit 121 sets the execution state 706 of the record to be processed to “doing” and sets the current date to the incentive start date 707 of the record to be processed.

In S1005, the management unit 121 notifies the user terminal 140 of the user who has granted the right of access to the demonstration version that the demonstration version has become available.

Next, the management unit 121 performs the process of S1006 to S1009 on each record in which the incentive is the right of demonstration use (the value of the incentive ID 705 is “I1”) and the process related to the incentive is under execution (the value of the execution state 706 is “doing”) among the records stored in the incentive management table.

In S1006, the management unit 121 determines whether to end the process related to the incentive based on the record to be processed.

More specifically, the management unit 121 determines whether the period of the parameter 304 of the record in the incentive definition table 300 associated with the incentive ID of the incentive ID 705 of the record to be processed has elapsed from the incentive start date of the incentive start date 707 of the record to be processed (whether the period in which the right of use of the demonstration version is granted has elapsed). In a case where it is determined that the period in which the right of use of the demonstration version is granted has elapsed, the management unit 121 moves the process to S1007, and in a case where it is determined that the period in which the right of use of the demonstration version is granted has not elapsed, the management unit 121 changes a record to be processed to the next record and moves the process to S1006.

In S1007, the access right control unit 122 deletes the right of access to the demonstration version from the user identified by the user ID of the user ID 703 of the record to be processed.

In S1008, the management unit 121 updates the record to be processed. For example, the management unit 121 sets the execution state 706 of the record to be processed to “done” and sets the current date to the incentive end date 708 of the record to be processed.

In S1009, the management unit 121 notifies the user terminal 140 of the user who has deleted the right of access to the demonstration version that the demonstration version cannot be used.

Next, a case where the incentive is the right of exemption from charging to the solution 112 will be described. Since the flow is basically the same as that of the process illustrated in FIG. 10, illustration is omitted, and description of the same steps is omitted.

First, the management unit 121 performs the process of S1002 to S1005 on each record in which the incentive is the right of exemption from charging (the value of the incentive ID 705 is “I2”) and the process related to the incentive is not executed (the value of the execution state 706 is “todo”) among the records stored in the incentive execution management table 700.

In S1002, the management unit 121 determines whether the solution 112 identified by the solution ID of the solution ID 704 of the record to be processed is registered in the solution repository 125. In a case where it is determined that the solution 112 is registered, the management unit 121 moves the process to S1003, and in a case where it is determined that the solution 112 is not registered, the management unit 121 changes a record to be processed to the next record and moves the process to S1002.

In S1003, the charging control unit 123 performs setting in which the user identified by the user ID of the user ID 703 of the record to be processed is exempted from charging to the use of the solution 112 (changes the price plan).

In S1005, the management unit 121 notifies the user terminal 140 of the user who has changed a price plan to the price plan for an exemption from charging of an exemption from charging to the use of the solution 112.

Next, the management unit 121 performs the process of S1006 to S1009 on each record in which the incentive is the right of exemption from charging (the value of the incentive ID 705 is “I2”) and the process related to the incentive is under execution (the value of the execution state 706 is “doing”) among the records stored in the incentive management table.

In S1006, the management unit 121 determines whether the period of the parameter 304 of the record of the incentive definition table 300 associated with the incentive ID of the incentive ID 705 of the record to be processed has elapsed from the incentive start date of the incentive start date 707 of the record to be processed (whether the period of an exemption from charging has elapsed). In a case where it is determined that the period of an exemption from charging has elapsed, the management unit 121 moves the process to S1007, and in a case where it is determined that the period of an exemption from charging has not elapsed, the management unit 121 changes a record to be processed to the next record, and moves the process to S1006.

In S1007, the charging control unit 123 performs setting in which charging is performed from the user identified by the user ID of the user ID 703 of the record to be processed (changes the price plan).

In S1009, the management unit 121 notifies the user terminal 140 of the user who has changed a price plan to the price plan in which charging is performed.

Next, a case where the incentive is the right of meeting will be described. Since the flow is basically the same as that of the process illustrated in FIG. 10, illustration is omitted, and description of the same steps is omitted.

First, the management unit 121 performs the process of S1002 to S1005 on each record in which the incentive is the right of meeting (the value of the incentive ID 705 is “I3”) and the process related to the incentive is not executed (the value of the execution state 706 is “todo”) among the records stored in the incentive execution management table 700.

In S1002, it is determined whether the demonstration version is deployed at a place assigned in advance. In a case where it is determined that the demonstration version is deployed, the management unit 121 moves the process to S1003, and in a case where it is determined that the demonstration version is not deployed, the management unit 121 changes a record to be processed to the next record, and moves the process to S1002.

In S1003, the management unit 121 sets (for example, generation of an e-mail including a URL or the like of an online meeting) a meeting in which the user identified by the user ID of the user ID 703 of the record to be processed can participate.

In S1005, the management unit 121 notifies the user terminal 140 of the user that the meeting is set.

Next, the management unit 121 performs the process of S1006 to S1009 on each record in which the incentive is the right of meeting (the value of the incentive ID 705 is “I3”) and the process related to the incentive is under execution (the value of the execution state 706 is “doing”) among the records stored in the incentive management table.

In S1006, the management unit 121 determines whether the remaining number of times (not illustrated) of the meeting in the record to be processed is zero. In a case where it is determined that the remaining number of times of the meeting is zero, the management unit 121 moves the process to S1007, and in a case where it is determined that the remaining number of times of the meeting is not zero, when the current date and time is the date and time when the meeting ends, the management unit 121 subtracts “1” from the remaining number of times of the meeting, changes a record to be processed to the next record, and moves the process to S1006.

In S1009, the management unit 121 notifies the user terminal 140 of the user identified by the user ID of the user ID 703 of the record to be processed that all meetings have been held.

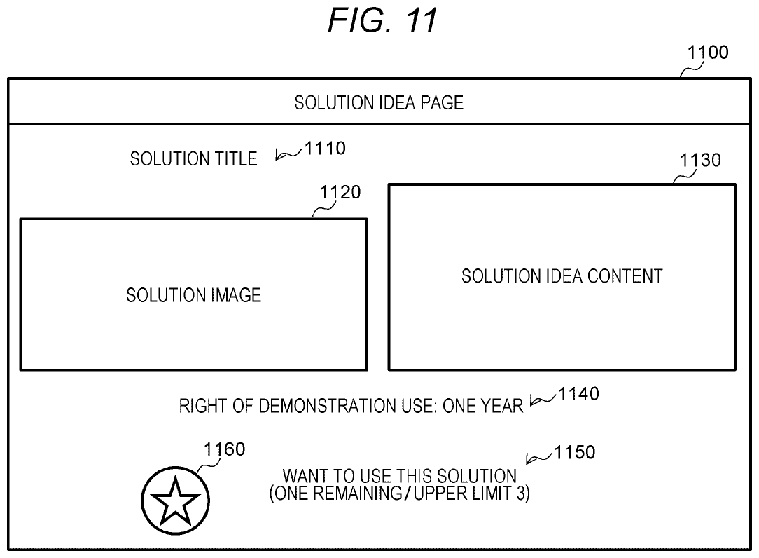

FIG. 11 is a diagram illustrating an example of a user screen (solution idea page 1100 for displaying solution idea 111 of predetermined solution 112).

The solution idea page 1100 includes a title display area 1110, an image display area 1120, an idea content display area 1130, an incentive content display area 1140, a selection count display area 1150, and a selection button 1160.

The title of the predetermined solution 112 is displayed in the title display area 1110. An image of the predetermined solution 112 is displayed in the image display area 1120. The idea content of the predetermined solution 112 is displayed in the idea content display area 1130. The content of the incentive associated with the predetermined solution 112 is displayed in the incentive content display area 1140. The selectable number and the upper limit number are displayed in the selection count display area 1150. The selection button 1160 is a button for accepting selection of an incentive associated with the predetermined solution 112 (intention expression to use the predetermined solution 112).

Note that the content of the incentive associated with the predetermined solution 112 may be displayed in the image display area 1120, the idea content display area 1130, the selection count display area 1150, or other areas.

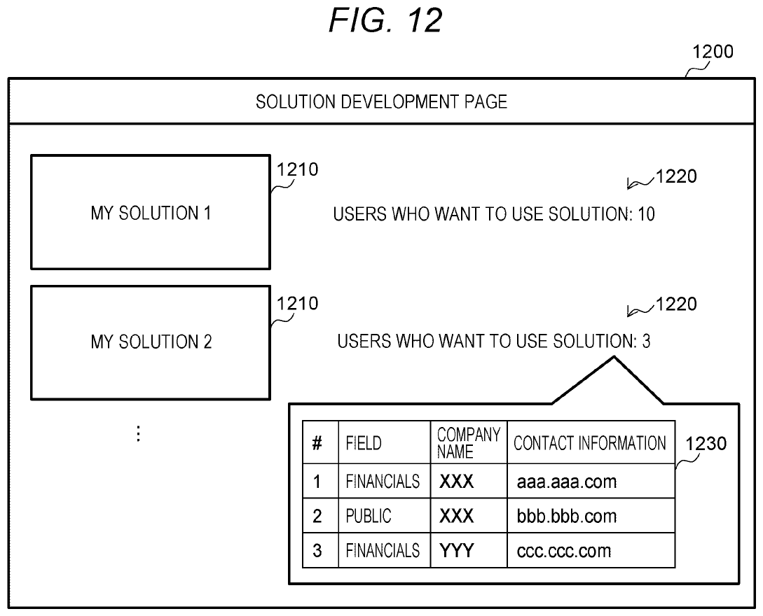

FIG. 12 is a diagram illustrating an example of a developer screen (solution development page 1200). The solution development page 1200 is generated by the management unit 121 in response to a request from a developer terminal (not illustrated) and an operation terminal such as a server device of the owner environment 110, and is displayed on the operation terminal.

The solution development page 1200 includes a solution display area 1210, a solution demand display area 1220, and a detail display area 1230.

Information related to the solution 112 developed by the developer is displayed in the solution display area 1210. The number of users who desire to use the solution 112 developed by the developer (information indicating the demand of the solution 112) is displayed in the solution demand display area 1220. Detailed information about the user who desires to use the solution 112 developed by the developer is displayed in the detail display area 1230. For example, the detail display area 1230 is displayed when the solution demand display area 1220 is pressed by the developer. According to the detail display area 1230, for example, the developer can grasp the correct demand for the solution 112 by analyzing the attribute of the user.

In order to improve the accuracy of the user's intention expression, the solution management system according to the present exemplary embodiment automatically executes granting of an incentive associated with a solution at appropriate timing, and records an execution trail thereof to ensure effectiveness. In addition, the solution management system automatically executes control of a right of access or the like by using the deployment of the solution associated with the incentive selected by the user as a trigger. In addition, the solution management system presents an upper limit number of intention expressions per user to the user, and gives an incentive associated with a solution selected in inverse proportion to the upper limit number.

According to the present embodiment, the user can accurately give an intention expression with an incentive associated with a solution, and the owner can grasp a correct demand for the solution. In addition, the platform can ensure the effectiveness of the incentive by leaving a trail.

### (II) Second Embodiment

The present embodiment is mainly different from the first embodiment in that an owner can set an incentive to be associated with the solution 112. In the present embodiment, the same components as those of the first embodiment are denoted by the same reference numerals, and the description thereof will be appropriately omitted.

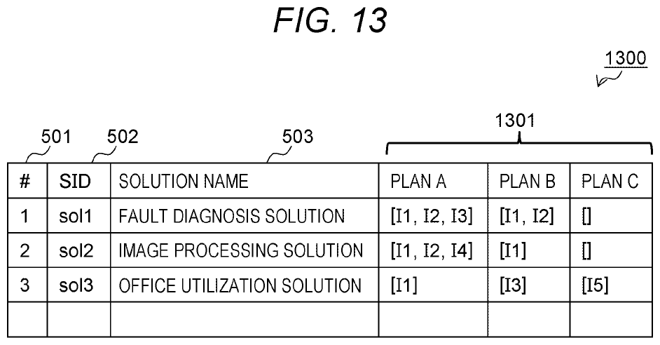

FIG. 13 is a diagram illustrating an example (solution management table 1300) of the solution management information 126C.

The solution management table 1300 stores a record in which information about a record number 501, a solution ID 502, a solution name 503, and an incentive plan 1301 is associated.

An incentive plan 1301 is an incentive (incentive plan) associated with the solution 112 by the owner. The incentive plan includes a plurality of incentives, one incentive, or no incentive.

Setting of the incentive plan is performed in an owner terminal (not illustrated) of the owner and an operation terminal such as a server device of the platform environment 120. Note that examples of a method of setting the incentive plan include input from a setting screen, reading of a CSV file, and the like, but the method is not limited thereto.

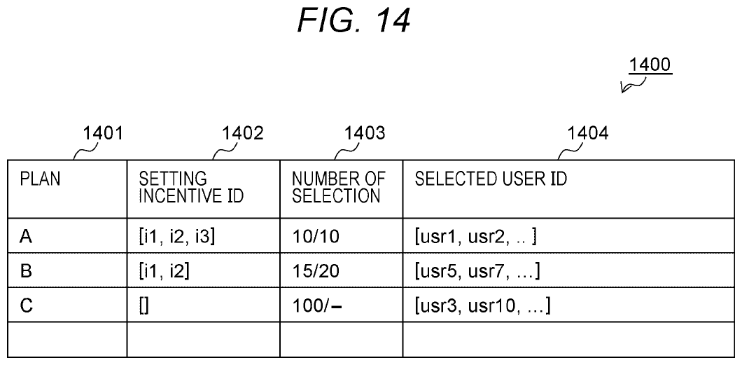

FIG. 14 is a diagram illustrating an example (selection plan management table 1400) of the solution management information 126C. The selection plan management table 1400 is provided for each solution 112 (solution ID). FIG. 14 illustrates an example in which the solution ID 502 of the solution management table 1300 is “sol1”.

The selection plan management table 1400 stores a record in which information about an incentive plan 1401, a setting incentive ID 1402, the number of selection 1403, and a selected user ID 1404 is associated.

The incentive plan 1401 is an incentive plan associated with the solution 112 whose solution ID 502 is “sol1” by the owner. The setting incentive ID 1402 is an incentive ID of an incentive included in the incentive plan. The number of selection 1403 is the number of users who have selected the incentive plan. For example, “15/20” indicates that the upper limit number of the incentive plan is “20” and is selected by “15” users. The selected user ID 1404 is a user ID of the user who has selected the incentive plan.

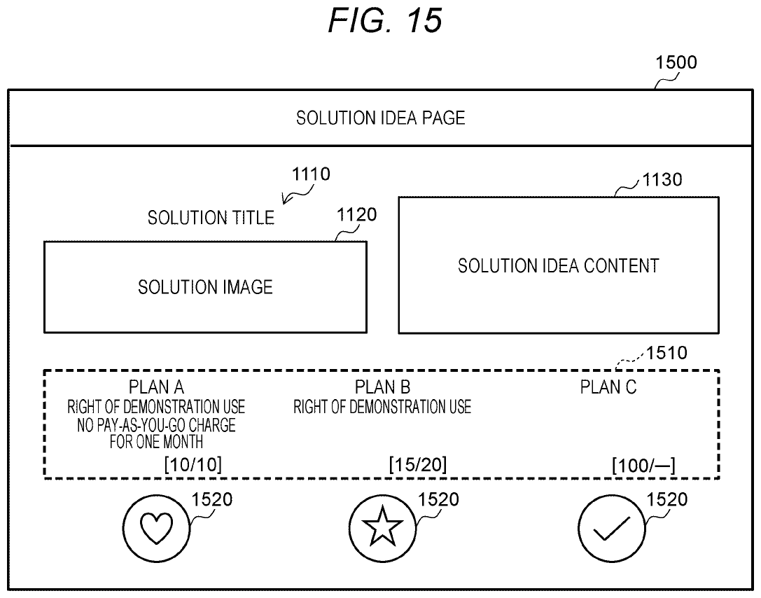

FIG. 15 is a diagram illustrating an example of a user screen (a solution idea page 1500 for displaying the solution idea 111 of the predetermined solution 112).

The solution idea page 1500 includes the title display area 1110, the image display area 1120, the idea content display area 1130, an incentive plan display area 1510, and a selection button 1520.

The incentive plan associated with the predetermined solution 112 is displayed in the incentive plan display area 1510. The selection button 1520 is a button for accepting selection (intention expression to use the predetermined solution 112) of an incentive plan associated with the predetermined solution 112.

Note that the solution idea page 1500 is not limited to the content described above. For example, the number of times the user is allowed to select the incentive plan, the number of times the user has selected the incentive plan, the remaining number of times the user is allowed to select the incentive plan, and the like may be displayed on the solution idea page 1500. Furthermore, in a case where the remaining number of times the user is allowed to select the incentive plan is zero, the selection button 1520 of the incentive plan may be deactivated.

According to the present embodiment, since the owner can freely set an incentive for a solution from among a plurality of predefined incentives having different strengths of intention expression, upper limit numbers, and the like, prediction accuracy of a demand for the solution can be improved.

### (III) Supplementary Note

The above-described embodiment includes, for example, the following contents.

In the above-described embodiment, the case where the present invention is applied to the solution management system is described, but the present invention is not limited thereto, and can be widely applied to other various systems, apparatuses, methods, and programs.

Furthermore, in the above-described embodiment, part or all of the program may be installed from a program source to a device such as a computer that realizes a server device. The program source may be, for example, a program distribution server connected via a network or a computer-readable recording medium (for example, a non-transitory recording medium). In addition, in the following description, two or more programs may be implemented as one program, or one program may be implemented as two or more programs.

Furthermore, in the above-described embodiment, the configuration of each table is an example, and one table may be divided into two or more tables, or all or part of two or more tables may be one table.

In addition, in the above-described embodiment, for convenience of description, the information related to the solution management system is described using the table, but the data structure is not limited to the table. The information related to the solution management system may be expressed by a data structure other than a table, such as an Extensible Markup Language (XML), a YAML Ain't a Markup Language (YAML), a hash table, or a tree structure.

Furthermore, in the above-described embodiment, the screen illustrated and described is an example, and any design may be used as long as the received information is the same.

Furthermore, in the above-described embodiment, the screen illustrated and described is an example, and may have any design as long as information to be presented is the same.

Furthermore, in the above-described embodiment, the output of information is not limited to display on a display. The output of the information may be audio output by a speaker, may be output to a file, may be printing on a paper medium or the like by a printing device, may be projection on a screen or the like by a projector, or may be another mode.

In the above description, information such as a program, a table, and a file for realizing each function can be stored in a storage device such as a memory, a hard disk, and a solid state drive (SSD), or a recording medium such as an IC card, an SD card, and a DVD.

The above-described embodiment has, for example, the following characteristic configurations.

(1)

A solution management system (for example, the solution management system 100) that manages a solution (for example, an image for generating a container) that is a product for utilizing a digital technology includes a generation unit (for example, the management unit 121, the generation unit, the server device, the VM, the circuit, and the like) that generates a user interface (for example, the user screen, the solution idea page 1100, or the like) in which a user is allowed to select an incentive (for example, the right of use of the solution, the right of exemption from charging, the right of meeting, and the like) associated with a solution, a storage unit (for example, the management unit 121, the storage unit, the server device, the VM, the circuit, and the like) that stores information (for example, the setting incentive ID associated with the solution ID of the selection solution ID 606) indicating the incentive, associated with the solution, selected by the user in the user interface generated by the generation unit, information (for example, the solution ID of the selection solution ID 606) indicating the solution, and information (for example, the user ID of the user ID 602) indicating the user in association with each other, an execution unit (for example, the management unit 121, the access right control unit 122, the charging control unit 123, the execution unit, the server device, the VM, the circuit, and the like) that monitors whether an application related to the solution is available and executes a process related to the incentive associated with the solution of the application that is available, and an output unit (for example, the management unit 121, the output unit, the server device, the VM, the circuit, and the like) that outputs a fact that the process related to the incentive is executed by the execution unit. For example, the output unit notifies the user terminal of the user who has selected the incentive that the process related to the incentive has been executed by the execution unit, for example.

According to the above configuration, for example, since an incentive associated with the solution can be obtained, the user expresses an intention according to his/her preference, and the accuracy of the intention expression can be improved. In addition, since the information indicating the solution associated with the incentive selected by the user is stored, for example, the owner of the solution can accurately grasp the demand for the solution.

(2)

The solution management system includes a reception unit (for example, the management unit 121, the reception unit, the server device, the VM, the circuit, and the like) that receives, from an owner of the solution, information on an incentive to be associated with the solution from among a plurality of pre-registered incentives (see, for example, FIG. 13).

According to the above configuration, for example, since an incentive suitable for the solution is set by the owner of the solution, the user expresses an intention more in accordance with his/her preference, and the accuracy of the intention expression can be further improved.

(3)

The generation unit generates a user interface (for example, a user screen, the solution idea page 1500, or the like) in which associated with one or a plurality of incentives associated with a solution can be selected a plan.

According to the above configuration, since the variation of the incentive presented to the user increases, for example, the owner can more precisely grasp the demand for the solution.

(4)

The generation unit generates a user interface (for example, a user screen, the solution idea page 1500, or the like) in which a first plan (for example, plan A and plan B) in which one or more incentives associated with a solution are associated and the number of selectable persons is limited, or a second plan (for example, plan C) in which an incentive associated with a solution is not associated and the number of selectable persons is not limited can be selected (see, for example, FIGS. 14 and 15).

According to the above configuration, since the variation of the incentive presented to the user increases, for example, the owner can more precisely grasp the demand for the solution. Furthermore, for example, according to a plan in which an incentive is not associated with a solution, the owner can grasp the degree of interest of the user in the solution.

(5)

The generation unit generates (see, for example, FIGS. 3, 5, 6, 8) a user interface in which a right of use for a test solution of the solution can be selected as an incentive associated with the solution, and in a case where an application generated based on the test solution is deployed, the execution unit sets the right of access to the application to the user who has selected the right of use (see, for example, FIG. 10).

According to the above configuration, for example, the owner can more accurately grasp the demand for the formal solution depending on whether the incentive associated with the formal solution is selected after the test solution is used.

(6)

The generation unit generates, as a user interface in which the user is allowed to select an incentive associated with a solution, a screen that displays an upper limit number indicating an upper limit in which the user is allowed to select a solution and a selectable number indicating the remaining number of times the user is allowed to select a solution (see, for example, FIG. 11).

In the above configuration, for example, by displaying the upper limit number and the selectable number for each user, it is possible to give a sense of limitation to the user, and the user expresses an intention more in accordance with his/her preference, and the accuracy of the intention expression can be further improved.

(7)

The storage unit stores the selectable number for each user, and resets the selectable number in a predetermined period.

According to the above configuration, since the selectable number is reset in a predetermined period, for example, the user can actively select an incentive, and can grasp the demand for the solution based on many intention expressions. Furthermore, for example, it is possible to avoid a situation in which the user cannot permanently express an intention when the selectable number is zero.

(8)

The generation unit generates a screen displaying an upper limit number indicating an upper limit in which the user is allowed to select the solution and the number of selection indicating the number of users who have selected the solution as a user interface in which the user is allowed to select an incentive associated with the solution (see, for example, FIG. 15).

According to the above configuration, for example, since the upper limit number and the number of selection are displayed for each solution, it is possible to give a sense of limitation to the user, so that the user expresses an intention at an early stage, and the owner can accurately and early grasp the demand for the solution.

In addition, the above-described configuration may be appropriately changed, redisposed, combined, or omitted without departing from the gist of the present invention.

What is claimed is:

1. A solution management system for managing a solution that is a product for utilizing digital technology, the solution management system comprising:
a generation unit that generates a user interface in which a user is allowed to select an incentive associated with a solution;
a storage unit that stores information indicating an incentive, associated with a solution, selected by a user in a user interface generated by the generation unit, information indicating the solution, and information indicating the user in association with each other;
an execution unit that monitors whether an application related to a solution is available and executes a process related to an incentive associated with a solution of the available application; and
an output unit that outputs a fact that the process related to the incentive is executed by the execution unit.

2. The solution management system according to claim 1, further comprising a reception unit that receives information about an incentive associated with a solution from an owner of the solution from among a plurality of pre-registered incentives.

3. The solution management system according to claim 1, wherein the generation unit generates a user interface in which a plan associated with one or a plurality of incentives associated with a solution can be selected.

4. The solution management system according to claim 1, wherein the generation unit generates a user interface in which a first plan in which one or more incentives associated with a solution are associated and the number of selectable persons is limited, or a second plan in which an incentive associated with a solution is not associated and the number of selectable persons is not limited is allowed to be selected.

5. The solution management system according to claim 1, wherein
the generation unit generates a user interface in which a right of use for a test solution of the solution is allowed to be selected as an incentive associated with the solution, and
when an application generated based on the test solution is deployed, the execution unit sets a right of access to the application to a user who has selected the right of use.

6. The solution management system according to claim 1, wherein the generation unit generates, as a user interface in which a user is allowed to select an incentive associated with a solution, a screen that displays an upper limit number indicating an upper limit in which the user is allowed to select a solution and a selectable number indicating a remaining number of times the user is allowed to select a solution.

7. The solution management system according to claim 6, wherein the storage unit stores the selectable number for each user and resets the selectable number in a predetermined period.

8. The solution management system according to claim 1, wherein the generation unit generates, as a user interface in which a user is allowed to select an incentive associated with a solution, a screen that displays an upper limit number indicating an upper limit in which a user is allowed to select the solution and the number of selection indicating the number of users selecting the solution.

9. A solution management method for managing a solution that is a product for utilizing a digital technology, the solution management method comprising:
generating, by a generation unit, a user interface in which a user is allowed to select an incentive associated with a solution;
storing, by a storage unit, information indicating an incentive, associated with a solution, selected by a user in a user interface generated by the generation unit, information indicating the solution, and information indicating the user in association with each other;
monitoring whether an application related to a solution is available and executing a process related to an incentive associated with a solution of the available application, by an execution unit; and
outputting, by an output unit, a fact that the process related to the incentive is executed by the execution unit.
